(19) United States
(12) Patent Application Publication
(10) Pub. No.: US 2006/0040651 A1
(43) Pub. Date: Feb. 23, 2006

(54) Pageable remote controller for A/V systems

(76) Inventor: Samuel Jaeyoon Won, Mercer Island, WA (US)

Correspondence Address: VOLENTINE FRANCOS, WHITT;Suite 1260, One Freedom Square, 11951 Freedom Drive, Reston, VA, 20191, US

(21) Appl. No.: 10/953,180

(22) Filed: Sep. 30, 2004

(30) Foreign Application Priority Data
Aug. 21, 2004 (KR) 2004-0066131

(51) Int. Cl. H04M 3/00

(52) U.S. Cl. 455/420

(57) ABSTRACT

The present invention discloses a remote controller having a buzzer with a wireless signal receiving circuit in order to respond to the paging signal from the main AN having a wireless signal transmitting circuit for paging. The remote controller makes it possible to locate the missing remote controller with ease wherever the remote controller is located, for instance, hidden under the sofa or inside the armchair.

### CROSS REFERENCE TO RELATED APPLICATION

This application claims priority under 35 USC § 119 to Korean Patent Application No. 2004-0066131, filed on Aug. 21, 2004, the contents of which are incorporated herein by reference in their entirety.

### FIELD OF THE INVENTION

The present invention relates to a remote controller for volume control or channel control of the A/V system, more particularly to a remote controller which can be paged and report its location especially when the remote controller cannot be found around the A/V system because it is hidden somewhere.

### BACKGROUND OF THE RELATED ART

Most of audio/video home appliances are equipped with IR (infrared) remote controller for the person watching television in the armchair, for instance, remotely to control the volume, channel, etc. Recently, a multi-purpose remote controller becomes available in the market which can control most of the audio and video units even if each unit is manufactured in different companies. As a consequence, a person sitting in the armchair can control most of home appliances with his IR remote controller.

It happens, however, that when the user tries to turn on the television he can hardly find the remote controller. He can not even remember where he put the remote controller and the remote controller does not show up despite his effort to locate.

### SUMMARY OF THE INVENTION

An object of the present invention is to provide a remote controller for AN system, which is has capability to report its location when paged by the user.

To accomplish the object of the present invention, the remote controller in accordance with the present invention has a buzzer with a wireless signal receiving circuit in order to respond to the paging signal from the main AN having a wireless signal transmitting circuit for paging. The remote controller in accordance with the present invention makes it possible to locate the missing remote controller with ease wherever the remote controller is located, for instance, hidden under the sofa or inside the armchair.

### BRIEF DESCRIPTION OF THE DRAWINGS

FIG. 1 is a schematic block diagram illustrating an A/V system equipped with a locatable remote controller in accordance with the present invention.

FIG. 2a is a schematic flow chart illustrating the working sequence of the microprocessor of the main AN unit in accordance with the present invention.

FIG. 2b is a schematic flow chart illustrating the working sequence of the microprocessor of the remote controller in accordance with the present invention.

### DETAILED DESCRIPTION OF THE INVENTION

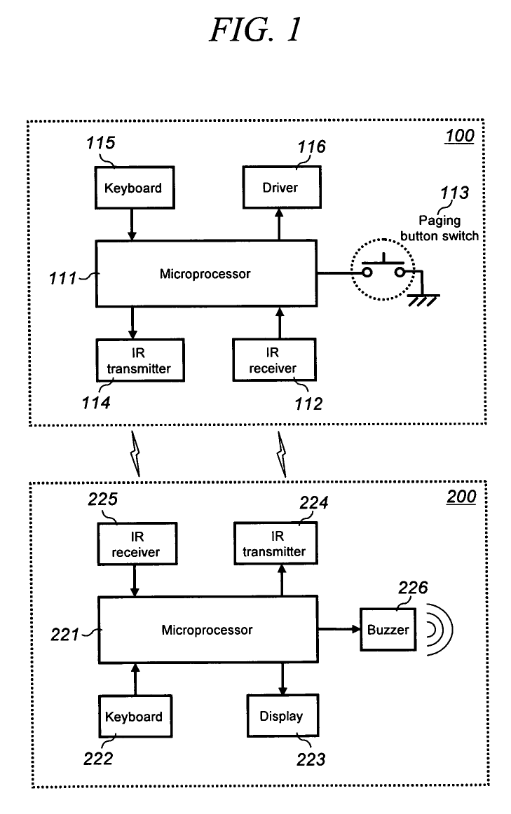

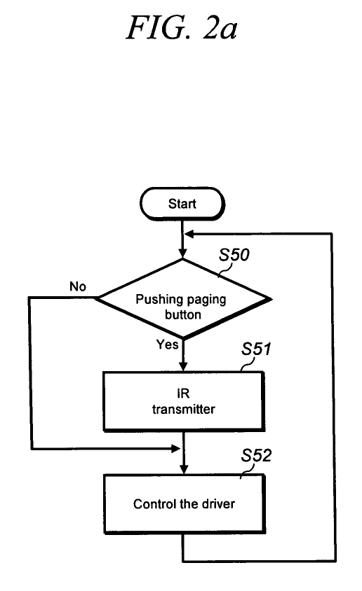

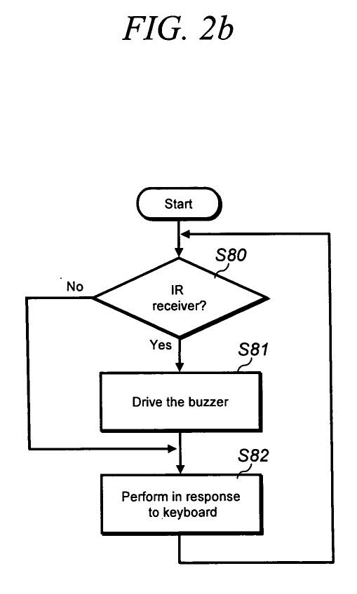

A remote controller with paging capability for A/V system is explained with reference to FIGS. 1 and 2, which illustrates how the missing remote controller can be located. FIG. 1 is a schematic block diagram illustrating an A/V system equipped with a locatable remote controller in accordance with the present invention. Referring to FIG. 1, the main A/V unit 100 and the remote controller 200 are depicted.

The main A/V unit 100 comprises a microprocessor 111, IR receiver 112 that detects the signal from the remote controller 200, a paging switch 113 for inputting the paging order to the microprocessor 111, a transmitter 114 sending the paging signal to the remote controller 200 under the control of the microprocessor 111, a driver 115 driven by the microprocessor 111, and a keyboard 116 for receiving commands from the user.

In the meanwhile, the remote controller 200 comprises a microprocessor 221, a keyboard 221 for receiving the user's command, a display 233 showing the operating status under the control of the microprocessor 221, an IR transmitter 224 for transmitting the signal to the main unit 100 under the control of the microprocessor 221, a receiver 225 for receiving the paging signal from the main unit 100 and inputting the signal to the microprocessor 221, and a buzzer 226 for advising the user of the current location.

When the user inputs the command to the microprocessor 221 by operating the keyboard 222 of the remote controller 200, the microprocessor 221 displays the current command in a display 223 and triggers the IR transmitter 224 to transmit the IR signal.

Further, when a command is inputted to the microprocessor 111 through a keyboard 115 or when the IR receiver 125 receives the signal transmitted from the transmitter 224 of the remote controller 200, the microprocessor 121 deciphers the command and sends the corresponding order to the driver 116.

When the user wants to locate the missing remote controller 200, he just pushes the paging button 113 on the main unit 100. Then, the microprocessor 211 deciphers the command from the paging button 113, make the IR transmitter 114 transmit the paging signal to the missing remote controller 200.

The IR receiver 225 of the remote controller 200 now receives the paging signal from the main unit 100, and directs the decoded signal to the microprocessor 221. The microprocessor 221 now understands that the main unit 100 is paging the remote controller 200 and lets the buzzer 226 ring for reporting its current location.

FIG. 2a is a schematic flow chart illustrating the working sequence of the microprocessor of the main AN unit in accordance with the present invention. Referring to FIG. 2a, the microprocessor determines if the paging button switch 113 is pushed (step S50). In case the button 113 is pushed, the IR paging signal is transmitted through the transmitter 114 (step S51). Thereafter, the driver 116 is controlled at step S52.

FIG. 2b is a schematic flow chart illustrating the working sequence of the microprocessor of the remote controller in accordance with the present invention. Referring to FIG. 2b, if the receiver 225 receives the paging signal at step S80, the buzzer 226 is driven to ring at step S81, followed by performing the operation in accordance with the keyboard 222 command at step S82.

The forgoing embodiments are merely exemplary and are not to be construed as limiting the present invention. The present teachings can be readily applied to other types of processes. The description of the present invention is intended to be illustrative, and not to limit the scope of the claims. Many alternatives, modifications, and variations will be apparent to those skilled in the art. Although the invention has been illustrated and described with respect to exemplary embodiments thereof, it should be understood by those skilled in the art that various other changes, omissions and additions may be made therein and thereto, without departing from the spirit and scope of the present invention. Therefore, the present invention should not be understood as limited to the specific embodiment set forth above but to include all possible embodiments which can be embodied within a scope encompassed and equivalents thereof with respect to the feature set forth in the appended claims.

What is claimed is:

1. A remote controller that remotely controls the operation of a main AN unit, wherein the main AN unit comprising:
a button switch for getting the user's paging command; and
a transmitter for sending the wireless paging signal to the remote controller, and wherein the remote controller comprising:
a receiver for receiving the paging signal from the main unit; and
a buzzer for ringing in response to the control signal from the receiver for reporting the current location.
